(19) United States
(12) Patent Application Publication
(10) Pub. No.: US 2022/0287272 A1
(43) Pub. Date: Sep. 15, 2022

(54) AUTOMATED CANINE TRAINING SYSTEM AND METHOD OF USE

(71) Applicant: Jeffrey R. Mitchell, University City, MO (US)

(72) Inventor: Jeffrey R. Mitchell, University City, MO (US)

(21) Appl. No.: 17/691,110

(22) Filed: Mar. 9, 2022

Related U.S. Application Data
(60) Provisional application No. 63/158,863, filed on Mar. 9, 2021.

(51) Int. Cl. A01K 15/02

(52) U.S. Cl. CPC A01K 15/021

(57) ABSTRACT

An automated training system includes a training space sized and shaped to accommodate animals and cameras that view the training space. The system also includes a reward device, a direction device, and a computing device in electrical communication with the cameras, reward device, and directions device, that operates a training portal within a digital environment. Animals reside in the training space and are monitored by the cameras while the animals interact with the direction device and reward device. The training portal operates the direction device to instruct the animals how to behave and then operates the reward device for the animals that comply with the instruction.

### CROSS-REFERENCE TO RELATED APPLICATIONS

The present application claims priority to U.S. Provisional Patent Application 63/158,863 filed Mar. 9, 2021, which is hereby incorporated by reference in its entirety.

BACKGROUND

The present disclosure generally relates to animal training systems and more specifically to an automated training system that controls and administers the instruction of animals so that they learn how to perform preselected tasks and exhibit selected behaviors without the manual contact of a trainer.

Common animal training systems utilize hands-on techniques and experienced human trainers to teach behaviors to animals, particularly canines. For example, a dog trainer will use a treat such as meat to reward a dog when it performs a task or exhibits a behavior such as sitting. A verbal command such as “sit” is given to the dog to associate the behavior with the sound and reward. Through repetition, the dog learns that it should sit when the command is given.

One of the problems associated with common animal training systems is their limited efficiency. For example, a trainer can only teach one animal at a time. While multiple animals may be present for the instruction the trainer cannot administer the timely reward or interaction with more than one animal at a time. If the command is given and the behavior is not promptly provided the animal will not learn as quickly or as well to perform the behavior.

Additionally, animals have unique traits and not all training methods are as effective for every animal either by type or specimen. While a trainer may know or be familiar with many training methods or techniques and can receive additional training the application of the methods is dependent on the skill of the trainer. It is then less likely that the appropriate method for each animal will be used by a trainer of skill and less so for an average trainer.

Although developments have been made in the area of common animal training systems, there remains a need for further improvement.

BRIEF SUMMARY

In one aspect, the present disclosure includes an automated training system comprising a training space sized and shaped to accommodate animals therein and a plurality of cameras that view the training space. The system also includes a reward device, a direction device, and a computing device in electrical communication with the plurality of cameras, reward device, and directions device, that operates a training portal within a digital environment. Animals reside in the training space and are monitored by the plurality of cameras while the animals interact with the direction device and reward device. The training portal operates the direction device to instruct the animals how to behave and then operates the reward device for the animals that comply with the instruction.

### BRIEF DESCRIPTION OF THE DRAWINGS

FIG. 1 is a diagram of an exemplary automated training system;

FIG. 2 is a simplified exemplary schematic of the computing device of the system of FIG. 1; and

FIG. 3 is a flowchart of a method of training animals.

Corresponding reference characters indicate corresponding parts throughout the drawings.

### DETAILED DESCRIPTION

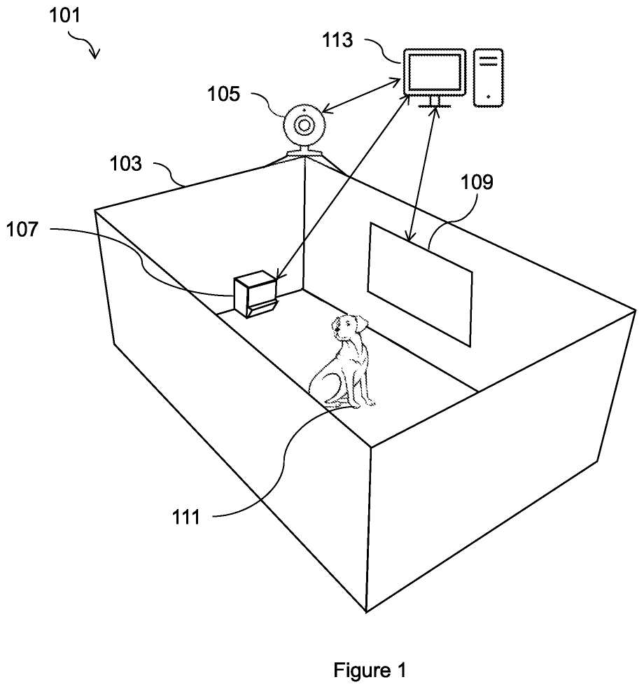

Referring now to the drawings and in particular to FIG. 1, an automated training system is designated in its entirety by the reference number 101. The illustrated system 101 includes a training space 103 that has accommodation for animals 111 that will reside therein. The system 101 also has cameras 105 that monitor the space 103 and detect the animals 111 that are placed therein. A reward device 107 is also located in the space 103 and is configured to provide an incentive or acknowledgment to the animals 111 based on an exhibited behavior. A direction device 109 is also located within the space 103 and is configured to prompt the animals 111 to behave or act in preplanned ways. A computing device 113 is in electronic communication with the cameras 105, reward device 107, and direction device 109.

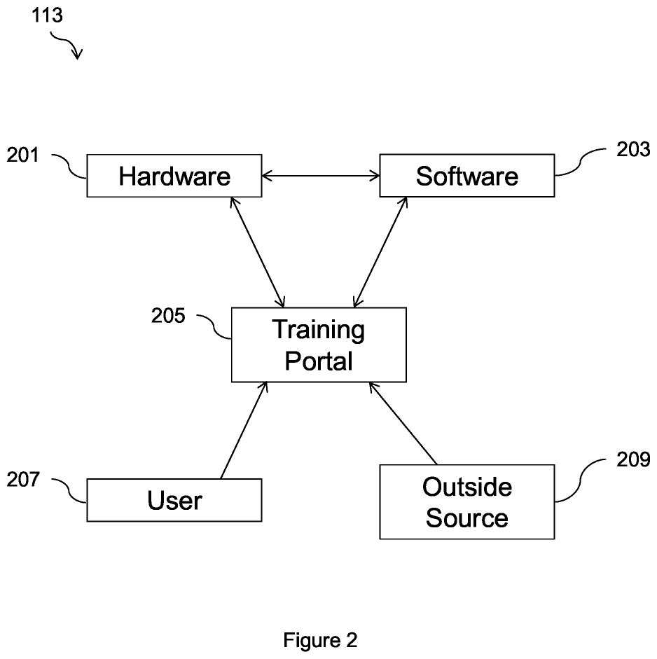

Referring to FIG. 2, the computing device is depicted and includes hardware 201 such as data storage, memory, processor, display, keyboard, and software 203 such as an operating system to create a digital environment wherein a training portal 205 is active and allows input from the cameras 105, a user 207, or an outside source 209. The outside source could be the internet, a program, or the like. The training portal 205 is configured to evaluate the animals 111 and through the operation of the reward device 107 and direction device 109 instruct the animals 111 to learn selected or preplanned behaviors.

In use, animals 111 such as canines are placed in the space 103 that could be indoors or out of doors. The animals 111 are allowed to act for themselves within the space 103. The direction device 109 as commanded by the training portal 205 provides stimulus such as visual, audio, or kinetic output that is seen, heard, or witnessed by the animals 111. The animals 111 choose to mimic, obey, or act on the stimulus and are thusly compensated by the reward device 107 as they are observed by the cameras 105. The training portal 205 accepts data from the cameras 105 and interprets it to determine compliance of specific animals, when compliance is identified, the training portal 205 activates the reward device 109 to compensate the specific animal. The animals that are deemed trained by the training portal 205, are graduated and new animals 111 are introduced to the space 103.

One unique feature of the invention is that a large number of animals 111 are observed by the cameras 105 and instructed within the space 103 by the direction device 109 and reward device 107 so that multiple animals are trained at the same time.

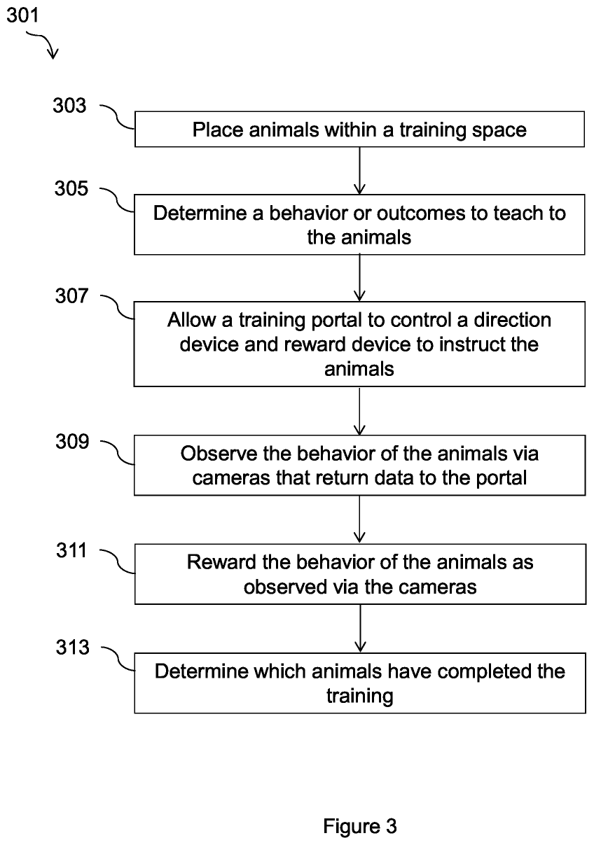

Referring now to FIG. 3, a method of training animals is depicted. Method 301 includes placing animals within a training space 303, determining a behavior or outcomes to teach to the animals 305, allowing a training portal to control a direction device and reward device to instruct the animals 307, observing the behavior of the animals via cameras that return data to the portal 309, rewarding the behavior of the animals as observed via the cameras 311, and determining which animals have completed the training 313.

Although the specification includes examples, the disclosure's scope is indicated by the following claims. Furthermore, although the specification has been described in language specific to structural features and/or methodological acts, the claims are not limited to the features or acts described above. Rather, the specific features and acts described above are disclosed as examples for embodiments of the disclosure.

As various changes could be made in the above constructions without departing from the scope of the invention, all matter contained in the above description or shown in the accompanying drawings shall be interpreted as illustrative and not in a limiting sense.

Insofar as the description above and the accompanying drawing disclose any additional subject matter that is not within the scope of the claims below, the disclosures are not dedicated to the public and the right to file one or more applications to claims such additional disclosures is reserved.

When introducing elements in this description, the articles “a”, “an”, “the”, and “said” are intended to mean that there are one or more of the elements. The terms “comprising”, “including”, and “having” are intended to be inclusive and mean that there may be additional elements other than the listed elements. claims what is claimed is:

1. An automated training system comprising:
a training space sized and shaped to accommodate animals therein;
a plurality of cameras that view the training space;
a reward device;
a direction device; and
a computing device in electrical communication with the plurality of cameras, reward device, and directions device, that operates a training portal within a digital environment;
wherein animals reside in the training space and are monitored by the plurality of camera while they interact with the direction device and reward device; and
wherein the training portal operates the direction device to instruct the animals how to behave and then operates the reward device for the animals that comply with the instruction.
